(19) United States
(12) Patent Application Publication
(10) Pub. No.: US 2008/0090717 A1
(43) Pub. Date: Apr. 17, 2008

(54) Glass Composition And Process For Producing The Same

(75) Inventors: Yukihito Nagashima, Tokyo (JP); Haruki Niida, Tokyo (JP); Junji Kurachi, Tokyo (JP); Akihiro Koyama, Tokyo (JP); Hiromitsu Seto, Tokyo (JP); Kazuhiro Yamamoto, Tokyo (JP); Daisuke Miyabe, Tokyo (JP); Yutaka Senshu, Tokyo (JP)

Correspondence Address: HAMRE, SCHUMANN, MUELLER & LARSON, P.C., P.O. BOX 2902, MINNEAPOLIS, MN, 55402-0902, US

(73) Assignee: NIPPON SHEET GLASS COMPANY, LIMITED, TOKYO (JP)

(21) Appl. No.: 11/793,171

(22) PCT Filed: Dec. 15, 2005
(86) PCT No.: PCT/JP05/23052

§ 371 Date: Sep. 12, 2007

(30) Foreign Application Priority Data
Dec. 16, 2004 (JP) 2004-364025
Aug. 15, 2005 (JP) 2005-235567

(51) Int. Cl. C03C 3/11

(52) U.S. Cl. 501/56

(57) ABSTRACT

The present invention provides a glass composition in which a smaller amount of arsenic oxide or antimony oxide that has a heavy burden on the environment is used and fewer bubbles remain. This glass composition includes, in terms of mass %: 40 to 70% of SiO₂, 5 to 20% of B₂O₃, 10 to 25% of Al₂O₃, 0 to 5% of MgO (up to and not including 5%), 0 to 20% of CaO, 0 to 20% of SrO, 0 to 10% of BaO, 0 to 1.5% of Li₂O, 0 to 1.5% of Na₂O, 0 to 1.5% of K₂O, and 0 to 1.5% of Cl. The sum of the contents of Li₂O, Na₂O, and K₂O is 0.05 to 1.5 mass %, and the content of K₂O is equal to or larger than that of Na₂O.

### TECHNICAL FIELD

The present invention relates to glass compositions and processes for producing the same. Particularly, it relates to aluminoborosilicate glass compositions and processes for producing the same.

### BACKGROUND ART

To prevent, for example, bubbles from remaining in a glass composition in the process for producing a glass composition is called “refining”. For refining a glass melt, a method in which a refining agent is added generally is known. Examples of well known refining agents include arsenic oxide, antimony oxide, and fluoride. However, since these components impose a heavy burden on the environment, a reduction in usage thereof is demanded by society.

Until now, an alkali-free borosilicate glass composition has been used for a glass composition to be used for a substrate of an information display, particularly, a liquid crystal display (LCD) of an active matrix type. Typical examples of alkali-free borosilicate glass include Code 7059 glass manufactured by Corning Incorporated, U.S. Since components such as aluminum, boron, and silicon can have high charges, they are electrostatically bound strongly and therefore are difficult to move in glass. Accordingly, generally, an alkali-free borosilicate glass composition has high viscosity and therefore it is not easy to refine the glass.

Until now, while avoiding the use of an undesirable refining agent that is typified by arsenic oxide, various processes for producing glass compositions to be used for substrates of liquid crystal displays have been studied.

JP 10(1998)-25132 A discloses that “0.005 to 1.0 wt % of sulfate in terms of SO₃ and 0.01 to 2.0 wt % of chloride in terms of Cl₂ are added as refining agents” to a glass raw material for obtaining an alkali-free borosilicate glass composition. In this publication, BaSO₄ and CaSO₄ are disclosed as sulfate and BaCl₂ and CaCl₂ are disclosed as chloride.

JP 60(1985)-141642 A discloses a low thermal expansion glass to be used for a photomask and a liquid crystal display. This glass is aluminoborosilicate glass that contains at least 5.0 mass % of MgO and tolerates 5.0 mass % or less of alkali metal oxide. JP 60(1985)-141642 A discloses that at least one selected from the group consisting of As₂O₃, Sb₂O₃, (NH₄)₂SO₄, NaCl, and fluoride is used as a bubble removal agent (refining agent) for low thermal expansion glass.

### DISCLOSURE OF INVENTION

JP 10(1998)-25132 A discloses BaCl₂ and CaCl₂ and JP 60(1985)-141642 A discloses NaCl, as refining agents that impose less burden on the environment.

However, according to the study of the inventors, a high refining effect cannot be obtained from chlorides of alkaline earth metals such as BaCl₂ and CaCl₂. Furthermore, when a glass composition containing a large amount of Na that was obtained by using NaCl as a refining agent is used for a glass substrate of a liquid crystal display, Na ions that migrate from the glass substrate may damage the performance of liquid crystal devices.

The present invention is intended to provide a glass composition containing fewer bubbles and having a composition suitable for an information display such as a liquid crystal display, and a process for producing the same. Furthermore, the present invention is intended to provide a glass substrate for an information display produced using the glass composition.

A first glass composition of the present invention is an aluminoborosilicate glass composition that contains a limited amount of alkali metal oxide, with the content of K₂O being equal to or larger than that of Na₂O.

This glass composition includes, in terms of mass %:

40 to 70% of SiO₂;

5 to 20% of B₂O₃;

10 to 25% of Al₂O₃;

0 to 5% of MgO (up to and not including 5%);

0 to 20% of CaO;

0 to 20% of SrO;

0 to 10% of BaO;

0 to 1.5% of Li₂O;

0 to 1.5% of Na₂O;

0 to 1.5% of K₂O; and

0 to 1.5% of Cl.

The sum of the contents of Li₂O, Na₂O, and K₂O is 0.05 to 1.5 mass % and the content of K₂O is equal to or larger than that of Na₂O.

A second glass composition of the present invention is an aluminoborosilicate glass composition that contains a small amount of K₂O and Cl as essential components.

This glass composition includes, in terms of mass %:

40 to 70% of SiO₂;

5 to 20% of B₂O₃;

10 to 25% of Al₂O₃;

0 to 10% of MgO;

0 to 20% of CaO;

0 to 20% of SrO;

0 to 10% of BaO;

0.05 to 1.5% of K₂O; and

0.04 to 1.5% of Cl.

From another aspect, the present invention provides a glass substrate for an information display that includes a glass sheet formed of a glass composition, with the glass composition being a first or second glass composition of the present invention.

From further another aspect, the present invention provides a process for producing the above-mentioned glass compositions.

This production process is a process for producing a glass composition including, in terms of mass %:

40 to 70% of SiO₂;

5 to 20% of B₂O₃;

10 to 25% of Al₂O₃;

0 to 10% of MgO;

0 to 20% of CaO;

0 to 20% of SrO;

0 to 10% of BaO;

0.05 to 1.5% of K₂O; and

0.04 to 1.5% of Cl.

The production process includes melting a glass raw material prepared so as to obtain the above-mentioned glass composition, with the glass raw material containing KCl.

A trace amount of alkali metal oxide considerably improves the effect of refining glass. Furthermore, K has a lower migration rate in a glass composition than that of Na. With consideration given to this, a trace amount of alkali metal oxide is tolerated in glass compositions of the present invention, and the K₂O content is allowed to be larger than the Na₂O content (first glass composition) or a trace amount of K₂O is added together with a trace amount of Cl (second glass composition). Moreover, in the production process of the present invention, KCl that has an excellent refining effect is added to a glass raw material.

According to the present invention, a sufficiently high refining effect can be obtained in an aluminoborosilicate glass composition without using or only using a very limited amount of components that impose a heavy burden on the environment and that are typified by arsenic oxide. The present invention facilitates the production of large glass substrates for information displays at a high yield and low cost while avoiding use of components that have a heavy burden on the environment.

### BRIEF DESCRIPTION OF DRAWINGS

FIG. 1 is a perspective view showing an example of the glass substrate for an information display of the present invention.

### DESCRIPTION OF THE PREFERRED EMBODIMENTS

Hereinafter, the unit “%” indicating the contents of the components of glass compositions always denotes mass %. The “glass composition of the present invention” described below refers to both the first and second glass compositions of the present invention.

In the glass composition of the present invention, the Cl content is preferably in the range of 0.04 to 1.5%. The Cl content can be in the range of 0.1 to 1.5% (from but not including 0.1%).

In the glass composition of the present invention, the sum of the contents of Li₂O, Na₂O, and K₂O is preferably in the range of 0.07 to 1.5% (from but not including 0.07%). The sum of the contents of Li₂O, Na₂O, and K₂O can be in the range of 0.2 to 1.5% (from but not including 0.2%).

In the glass composition of the present invention, the Na₂O content is preferably in the range of 0 to 1.0% (up to and not including 1.0%).

In the glass composition of the present invention, the K₂O content is preferably in the range of 0.05 to 1.5%, particularly 0.07 to 1.5%.

In the glass composition of the present invention, it is preferable that the K₂O content be in the range of 0.05 to 1.5% and the Cl content be in the range of 0.04 to 1.5%.

Preferably, the glass composition of the present invention is substantially free from As₂O₃ and Sb₂O₃. This is because these compounds have a heavy burden on the environment. The glass composition of the present invention can be substantially free from As₂O₃, Sb₂O₃, and fluoride.

In this specification, the expression “substantially free” denotes that a trace amount of components that are contained inevitably in industrial production are tolerated, and specifically it denotes that the content thereof is lower than 0.3%, preferably lower than 0.1%, and more preferably lower than 0.04%.

The glass composition of the present invention has preferably a glass transition temperature in the range of 690° C. or higher, more preferably 720° C. or higher.

Preferably, the second glass composition of the present invention or a glass composition obtained by the production process of the present invention includes the following components:

58 to 70% of SiO₂;

8 to 13% of B₂O₃;

13 to 20% of Al₂O₃;

1 to 5% of MgO;

1 to 10% of CaO;

0 to 4% of SrO;

0 to 1% of BaO;

0.05 to 1.5% of K₂O; and

0.04 to 1.2% of Cl.

In the second glass composition of the present invention or a glass composition obtained by the production process of the present invention, the upper limit of the contents of Li₂O and Na₂O can be limited to 1.5%. In this case, the glass composition can be described as a composition containing the following components (the values described in the parentheses indicate preferable ranges):

40 to 70% (58 to 70%) of SiO₂;

5 to 20% (8 to 13%) of B₂O₃;

10 to 25% (13 to 20%) of Al₂O₃;

0 to 10% (1 to 5%) of MgO;

0 to 20% (1 to 10%) of CaO;

0 to 20% (0 to 4%) of SrO;

0 to 10% (0 to 1%) of BaO;

0 to 1.5% of Li₂O;

0 to 1.5% of Na₂O;

0.05 to 1.5% of K₂O; and

0.04 to 1.5% of Cl.

In the first glass composition of the present invention, the K₂O content is equal to or larger than the Na₂O content, preferably larger than the Na₂O content. Similarly, in the second glass composition of the present invention, the relationship between the K₂O content and the Na₂O content can be the same as in the first glass composition. In the glass composition of the present invention, the K₂O content can exceed the sum of the contents of Na₂O and Li₂O. The glass composition of the present invention can be substantially free from Na₂O and Li₂O.

In the process for producing a glass composition of the present invention, KCl is added as a part of the glass raw material. Since the chlorides (BaCl₂, CaCl₂) of alkaline earth metals that are used in JP 10(1998)-25132 A described above have high boiling points and are difficult to move in glass, they tend not to cause rapid boiling even when the temperature exceeds the boiling temperature. Accordingly, a sufficiently high refining effect cannot be obtained from chlorides of alkaline earth metals. On the other hand, since KCl is a monovalent salt, it is electrically-bound weakly in molten glass. Furthermore, since potassium has a larger ion radius than that of sodium, it does not have a high degree of freedom of movement due to steric hindrance in a glass composition that has a dense structure after being cooled from the molten state and having a contracted volume.

Accordingly, KCl has excellent properties in that it moves in glass melted at high temperature and gets into bubbles to exhibit a bubble removing effect while the problem of migration of alkali components from the resultant glass composition tends not to be caused. KCl has a boiling point of around 1510° C. and volatilizes at a higher temperature than that at which NaCl volatilizes, whose boiling point is 1413° C. Therefore the use of KCl is particularly advantageous for refining glass with higher viscosity such as aluminoborosilicate glass.

Furthermore, a refining furnace that has a complicated structure to be provided with, for example, airtightness is used in reduced pressure refining where bubble removing is performed under a reduced-pressure atmosphere. In this case, it is preferable that the refining be carried out at a lower temperature (about 1450° C. to 1500° C.) than a temperature (at least 1600° C.) at which it is generally is carried out. Therefore KCl that has charges subjected to weaker binding as compared to chlorides of alkaline earths and that is easy to move in molten glass with high viscosity is particularly advantageous in reduced pressure refining.

The Cl content in glass tends to be lower than that in the raw material due to its volatility. Accordingly, when the raw material contains a trace amount of Cl, Cl may not be detected from a resultant glass composition even if a Cl source such as KCl is used for the raw material.

Alkali metal oxides such as Li₂O, Na₂O, and K₂O migrate from glass to affect other members. Therefore they have been excluded from glass compositions to be used for glass substrates for liquid crystal displays until now. However, when being used in a trace amount, alkali metal oxides, especially K₂O, are useful components for improving the effect of refining glass while suppressing the effect of migration from glass to a practically allowable level. Alkali metal oxides lower the glass viscosity and contribute to promoting the dissolution of silica that tends not to be easily dissolved in a raw material.

However, when no Cl source is used for the raw material and refining is carried out depending totally on addition of alkali metal oxides, it is necessary to adjust the content of K₂O in the glass composition to be equal to or larger than the Na₂O content, preferably to exceed the Na₂O content. This is because limiting the content of Na₂O having a relatively high migration rate in glass prevents diffusion of alkali metal from glass.

Preferably, the glass composition of the present invention contains at least two alkali metal oxides. When at least two alkali metal oxides exist together in a glass composition, the migration rates of those alkali metal ions further can be reduced due to a mixed alkali effect. This allows a further reduction in diffusion of alkali metal or alkali metal ions from a glass composition, and thereby an effect of improving the chemical durability of the glass composition can be obtained. The glass composition of the present invention contains preferably K₂O, and Na₂O and/or Li₂O.

The process for forming a glass composition of the present invention is not particularly limited, but can be a down draw process or a fusion process.

The respective components of the glass compositions are described below.

<SiO₂>

SiO₂ is an essential component forming the skeleton of glass and has an effect of improving chemical durability and heat resistance of the glass. When the content thereof is lower than 40%, the effect cannot be obtained satisfactorily. On the other hand, when the content exceeds 70%, the glass tends to devitrify to become difficult to form, while the viscosity increases to make it difficult to homogenize glass. Accordingly, the SiO₂ content is 40 to 70%, more preferably 58 to 70%.

<B₂O₃>

B₂O₃ is an essential component that lowers the viscosity of glass and promotes melting and refining of the glass. When the content thereof is lower than 5%, the effects cannot be obtained satisfactorily. On the other hand, when the content exceeds 20%, the acid resistance of the glass decreases and strong volatilization is caused making it difficult to homogenize the glass. Accordingly, the B₂O₃ content is 5 to 20%, more preferably 8 to 13%.

<Al₂O₃>

Al₂O₃ is an essential component forming the skeleton of glass and has an effect of improving chemical durability and heat resistance of the glass. When the content thereof is lower than 5%, the effect cannot be obtained satisfactorily. On the other hand, when the content exceeds 25%, the viscosity and acid resistance of the glass are deteriorated. Accordingly, the Al₂O₃ content is 10 to 25%, more preferably 13 to 20%.

<MgO and CaO>

MgO and CaO are optional components that lower the viscosity of glass and promote melting and refining of the glass. When the contents thereof exceed 10% and 20%, respectively, the chemical durability of the glass is deteriorated. Accordingly, the MgO content is 0 to 10%, and the CaO content is 0 to 20%.

In order to improve the refining effect by using Cl, it is preferable that the content of each of MgO and CaO be at least 1%. Furthermore, in order to prevent the glass from devitrifying, the contents thereof are preferably 5% and 10%, respectively. Accordingly, the MgO and CaO contents are more preferably 1 to 5% and 1 to 10%, respectively. Further preferably, the MgO content is lower than 5%.

<SrO and BaO>

SrO and BaO are optional components that lower the viscosity of glass and promote melting and refining of the glass. When the contents thereof exceed 20% and 10%, respectively, the chemical durability of the glass is deteriorated. Furthermore, their large ion radii may hinder the movement of potassium ions and chloride ions in glass and thereby may make it difficult to refine the glass. Accordingly, the SrO content is 0 to 20%, preferably 0 to 4%. The BaO content is 0 to 10%, preferably 0 to 1%.

<K₂O, Na₂O, and Li₂O>

K₂O is a component that lowers the viscosity of glass and promotes melting and refining of the glass.

K₂O is bound to chlorine ions contained in a glass melt and evaporates as potassium chloride at a temperature of 1500° C. or higher. Thus K₂O promotes expansion and surfacing of bubbles in glass. Accordingly, the flux caused thereby provides an effect of homogenizing the glass melt. The K₂O content can be 0% when predetermined conditions are satisfied, but it is preferably at least 0.05% and more preferably at least 0.07%.

On the other hand, since K₂O may increase the thermal expansion coefficient of the glass, the K₂O content is desirably 1.5% or lower to prevent the occurrence of the difference in thermal expansion coefficient between the glass and a silicon material.

K₂O has a lower migration rate in the glass and tends not to diffuse from the glass as compared to Na₂O and Li₂O that are also alkali metal oxides. Therefore among the alkali metal oxides, K₂O is a suitable component for glass substrates for information displays such as liquid crystal displays. In order to prevent alkali metal oxides from migrating from the glass, the Na₂O content is desirably equal to or lower than the K₂O content. For instance, the Na₂O content is desirably in the range of 0 to 1.0% (up to and not including 1.0%), preferably in the range of 0 to 0.5%, and further preferably in the range of 0 to 0.1%.

Li₂O is an optional component that lowers the viscosity of glass and promotes refining of the glass. Like K₂O, Li₂O also evaporates as lithium chloride and thus has effects of allowing bubbles in glass to expand and surface and homogenizing the glass melt at the same time. Furthermore, the addition of a trace amount of Li₂O makes it possible to lower the surface resistance and volume resistance or electrical resistance of the glass composition to prevent it from being charged. The content thereof is desirably in the range of 0 to 0.5% and preferably 0.07% or lower.

<Cl>

The Cl content can be 0%, but is preferably at least 0.04% because Cl is a component that can promote refining of glass. As described above, the Cl content tends to be lower in the glass than in the raw material due to its volatility. Accordingly, it is preferable that Cl be added to a glass raw material batch so that the content thereof is at least 0.05% in the glass composition, for example.

However, since the solubility of Cl in the glass is not high, when the content thereof exceeds 1.5%, Cl may condense in the glass during the formation, may form bubbles containing chloride crystals, and may tend to cause phase separation and devitrification of the glass. Accordingly, the Cl content is desirably 1.5% or lower.

K₂O and Cl can be added by using different supply sources. However, since the absolute contents thereof are low, they are bound to each other through competition with other ions. As a result, they may not be bound to each other satisfactorily.

On the other hand, when potassium chloride (KCl) is added as K₂O and Cl sources, KCl can be present from the early stage. Therefore, when the glass temperature exceeds the boiling point of KCl, rapid bubbling tends to be caused, which is advantageous in refining. Accordingly, it is preferable that KCl be used as K₂O and Cl sources.

<Mixed Alkali Effect>

The content of R₂O that is expressed as the sum of contents of alkali metal oxides, for example, the sum of contents of Li₂O, Na₂O and K₂O is in the range of 0.05 to 1.5%, preferably in the range of 0.07 to 1.5% (from but not including 0.07%).

However, since Li₂O, Na₂O, and K₂O are alkali metal oxides, cations thereof tend to move in glass easier as compared to other metal cations.

Among the above-mentioned alkali metal oxides, K₂O has a lowest migration rate in glass. As described above, however, when K₂O and Li₂O and/or Na₂O are allowed to exist together in a glass composition, an effect of improving chemical durability of the glass composition can be obtained.

Furthermore, when a plurality of alkali metal oxides are allowed to be present together, a better refining effect can be obtained as compared to the case where one alkali metal oxide is contained. This better refining effect can be obtained particularly prominently when K₂O and Li₂O are present together.

<Other Components>

The glass composition of the present invention can be a composition consisting essentially of the above-mentioned components (SiO₂, B₂O₃, Al₂O₃, MgO, CaO, SrO, BaO, Li₂O, Na₂O, K₂O, and Cl). In this case, the glass composition of the present invention is substantially free from components other than those described above.

However, the glass composition of the present invention further can contain other components for the purposes, for example, of controlling the refractive index and temperature-viscosity characteristics and improving the devitrification property. Specific examples of other components include Y₂O₃, La₂O₃, Ta₂O₅, Nb₂O₅, GeO₂, and Ga₂O₅. Preferably, these components are contained in such a manner that the sum of the contents thereof is 3% or less.

Components that are not mentioned above may be contained as a trace amount of impurities in industrially available glass raw materials. Examples of the trace amount of impurities include Fe₂O₃. When the total content of those impurities is lower than 0.5%, they have a small effect on the properties of the glass composition and therefore cause no practical problems.

In the glass composition of the present invention, it is possible to obtain an excellent glass refining property while using a reduced amount of arsenic oxide or antimony oxide. The present invention does not require a complete exclusion of components, such as As and Sb, that impose a heavy burden on the environment. As described above, it is preferable that the glass composition of the present invention be substantially free from oxides of As and Sb, but is not limited to this. In the case of Sb that imposes a smaller burden on the environment as compared to As, it can be contained in the range of less than 4% in terms of oxide.

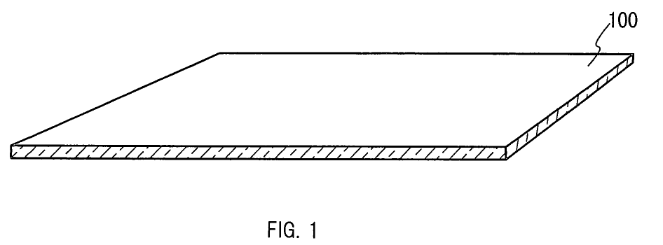

The glass composition of the present invention is suitable to be used for a glass substrate 100 for a large and thin information display that is suitable to be used, for example, for a liquid crystal display or a plasma display panel as shown in FIG. 1.

Embodiments of the present invention are described below using examples. The present invention, however, is not limited to the following.

### Examples 1 to 15 and Comparative Examples 1 and 2

Glass raw material batches (hereinafter also referred to as “batches”) indicated in Tables 1 and 2 were prepared, respectively. The common glass raw materials used herein include silica (silicon oxide), boric acid anhydride, alumina, basic magnesium carbonate, calcium carbonate, strontium carbonate, barium carbonate, lithium carbonate, sodium carbonate, and potassium carbonate. In addition, potassium chloride, calcium chloride, sodium chloride, and lithium chloride were used as Cl sources.

TABLE 1

| | | Ex. 1 | Ex. 2 | Ex. 3 | Ex. 4 | Ex. 5 | Ex. 6 | Ex. 7 | Ex. 8 | Ex. 9 |
|---|---|---|---|---|---|---|---|---|---|---|
| Mixing | Silicon oxide | 59.0 | 58.0 | 58.0 | 59.6 | 59.4 | 58.9 | 54.7 | 54.5 | 54.0 |
| Ratio | Boric acid anhydride | 8.8 | 8.8 | 8.8 | 9.5 | 9.4 | 9.4 | 11.0 | 10.9 | 10.8 |
| [g/batch] | Aluminum oxide | 17.0 | 17.0 | 17.0 | 15.2 | 15.1 | 15.0 | 13.8 | 13.8 | 13.6 |
| | Magnesium carbonate | 6.0 | 5.9 | 5.9 | 3.8 | 3.8 | 3.8 | 1.2 | 1.2 | 1.1 |
| | Calcium carbonate | 6.5 | 5.9 | 5.9 | 9.1 | 9.0 | 8.9 | 7.7 | 7.6 | 7.6 |
| | Strontium carbonate | 2.1 | 2.1 | 2.1 | 2.4 | 2.4 | 2.4 | 4.0 | 4.0 | 4.0 |
| | Barium carbonate | — | — | — | — | — | — | 7.3 | 7.3 | 7.2 |
| | Lithium carbonate | — | — | — | — | — | — | — | — | — |
| | Sodium carbonate | — | — | — | — | — | — | — | — | — |
| | Potassium carbonate | — | — | — | — | — | — | — | — | — |
| | Lithium chloride | — | — | — | — | — | — | — | — | — |
| | Sodium chloride | — | — | — | — | — | — | — | — | — |
| | Calcium chloride | — | 0.6 | — | — | — | — | — | — | — |
| | Potassium chloride | 0.8 | 0.8 | 1.7 | 0.4 | 0.9 | 1.7 | 0.4 | 0.8 | 1.6 |

TABLE 2

| | | Ex. 10 | Ex. 11 | Ex. 12 | Ex. 13 | Ex. 14 | Ex. 15 | C. Ex. 1 | C. Ex. 2 |
|---|---|---|---|---|---|---|---|---|---|
| Mixing | Silicon oxide | 59.4 | 54.5 | 54.1 | 54.5 | 54.6 | 54.4 | 59.0 | 59.0 |
| Ratio | Boric acid anhydride | 9.5 | 10.9 | 10.8 | 10.9 | 10.9 | 10.9 | 8.9 | 8.9 |
| [g/batch] | Aluminum oxide | 15.1 | 13.8 | 13.7 | 13.8 | 13.8 | 13.7 | 17.0 | 17.0 |
| | Magnesium carbonate | 3.8 | 1.2 | 1.1 | 1.2 | 1.2 | 1.2 | 6.0 | 6.0 |
| | Calcium carbonate | 9.0 | 7.6 | 7.6 | 7.6 | 7.7 | 7.6 | 6.5 | 6.5 |
| | Strontium carbonate | 2.4 | 4.0 | 4.0 | 4.0 | 4.0 | 4.0 | 2.1 | 2.1 |
| | Barium carbonate | — | 7.3 | 7.2 | 7.3 | 7.3 | 7.3 | — | — |
| | Lithium carbonate | — | — | — | — | — | — | — | — |
| | Sodium carbonate | — | — | — | — | — | — | — | — |
| | Potassium carbonate | 0.8 | 0.8 | 1.5 | — | — | — | — | — |
| | Lithium chloride | — | — | — | — | 0.2 | 0.2 | — | — |
| | Sodium chloride | — | — | — | 0.3 | — | 0.3 | — | 0.7 |
| | Calcium chloride | — | — | — | — | — | — | 0.6 | — |
| | Potassium chloride | — | — | — | 0.4 | 0.4 | 0.4 | — | — |

Each batch thus prepared was melted and refined in a platinum crucible. First, this crucible was kept in an electric furnace whose temperature was set at 1600° C. for 16 hours. Thus it was melted. Thereafter, the crucible containing a glass melt was taken out of the furnace and was allowed to stand to cool at room temperature and to be solidified. Thus a glass body was obtained. This glass body was taken out of the crucible and was subjected to an annealing operation. The annealing operation was carried out by maintaining the glass body in another electric furnace whose temperature was set at 700° C. for 30 minutes, then turning off the power supply of the electric furnace, and cooling it to room temperature. The glass body subjected to this annealing operation was used as a glass sample.

<Quantification of Glass Composition>

The glass sample was crushed and then the glass composition was quantified by a fluorescent X-ray analysis method (RIX3001 manufactured by Rigaku Industrial Corp.). With respect to boron (B), it was quantified by an emission spectroscopic method (ICPS-1000IV manufactured by Shimadzu Corp.).

<Evaluation of Degree of Refining>

Degree of refining of the glass body was evaluated by observing the above-mentioned glass sample with an optical microscope of 40 times magnification and calculating the number of bubbles per 1 cm³ of the glass from the thickness, viewing area, and the number of bubbles observed. Since this method is a simple melting method using a crucible, the number of bubbles thus calculated is much larger than that of bubbles contained in glass bodies produced practically on an industrial scale. However, it has been proved that the smaller the number of bubbles calculated by this method, the smaller the number of bubbles contained in a glass body produced on an industrial scale. Accordingly, this method can be used as an index of refining.

<Measurement of Thermal Expansion Coefficient and Glass Transition Point>

Furthermore, these glass samples were processed by a common glass processing technique and thereby glass sample pieces were produced in the form of a column with a diameter of 5 mm and a length of 15 mm. These glass sample pieces were measured for the thermal expansion coefficient and glass transition point at a temperature increase rate of 5° C./min using a differential thermal dilatometer (Thermoflex TMA8140 manufactured by Rigaku Corp.).

### Results of Examples 1 to 15

The respective glass samples produced as described above had the compositions indicated in Tables 3 and 4. The number of bubbles remaining in the glass samples of Examples 1 to 15 is much smaller as compared to Comparative Examples. Moreover, no refining agent imposing a heavy burden on the environment, such as arsenic oxide, was added to the glass samples of Examples 1 to 15. Therefore, the glass composition of the present invention makes it possible to produce glass substrates having a very few defects such as bubbles, using a reduced amount of arsenic oxide or without using arsenic oxide, for example.

TABLE 3

| | | Ex. 1 | Ex. 2 | Ex. 3 | Ex. 4 | Ex. 5 | Ex. 6 | Ex. 7 | Ex. 8 | Ex. 9 |
|---|---|---|---|---|---|---|---|---|---|---|
| Composition[%] | SiO₂ | 63.3 | 63.2 | 63.2 | 64.9 | 64.8 | 64.2 | 59.6 | 59.4 | 59.0 |
| | B₂O₃ | 8.6 | 8.6 | 8.6 | 9.1 | 9.1 | 9.0 | 10.6 | 10.5 | 10.4 |
| | Al₂O₃ | 18.7 | 18.7 | 18.7 | 16.6 | 16.5 | 16.3 | 15.0 | 15.0 | 14.9 |
| | MgO | 3.1 | 3.1 | 3.1 | 1.7 | 1.6 | 1.6 | 0.5 | 0.5 | 0.5 |
| | CaO | 3.9 | 3.8 | 3.5 | 5.5 | 5.5 | 5.5 | 4.7 | 4.7 | 4.6 |
| | SrO | 1.6 | 1.6 | 1.6 | 1.8 | 1.8 | 1.8 | 3.1 | 3.1 | 3.1 |
| | BaO | — | — | — | — | — | — | 6.2 | 6.2 | 6.1 |
| | Li₂O | — | — | — | — | — | — | — | — | — |
| | Na₂O | — | — | — | — | — | — | — | — | — |
| | K₂O | 0.50 | 0.48 | 0.87 | 0.29 | 0.59 | 1.17 | 0.28 | 0.56 | 1.11 |
| | Cl | 0.27 | 0.52 | 0.49 | 0.09 | 0.18 | 0.35 | 0.09 | 0.17 | 0.33 |

| | | | | | | | | | |
|---|---|---|---|---|---|---|---|---|---|
| Glass transition temp. [° C.] | 747 | 747 | 742 | 745 | 742 | 738 | 729 | 726 | 722 |
| Expansion Coefficient [×10⁻⁷/° C.] | 33 | 33 | 33 | 34 | 35 | 37 | 38 | 39 | 41 |
| State of bubbles | Good | Good | Very | good | Very | Very | good | good | Very |
| | | | good | | good | good | | | good |

TABLE 4

| | | Ex. 10 | Ex. 11 | Ex. 12 | Ex. 13 | Ex. 14 | Ex. 15 | C. Ex. 1 | C. Ex. 2 |
|---|---|---|---|---|---|---|---|---|---|
| Composition[%] | SiO₂ | 64.9 | 59.5 | 59.2 | 59.4 | 59.5 | 59.3 | 63.4 | 63.5 |
| | B₂O₃ | 9.1 | 10.5 | 10.5 | 10.5 | 10.5 | 10.5 | 8.6 | 8.6 |
| | Al₂O₃ | 16.5 | 15.0 | 14.9 | 15.1 | 15.1 | 15.0 | 18.7 | 18.7 |
| | MgO | 1.6 | 0.5 | 0.5 | 0.5 | 0.5 | 0.5 | 3.1 | 3.1 |
| | CaO | 5.5 | 4.7 | 4.7 | 4.7 | 4.7 | 4.7 | 4.3 | 3.9 |
| | SrO | 1.8 | 3.0 | 3.0 | 3.1 | 3.1 | 3.1 | 1.6 | 1.6 |
| | BaO | — | 6.2 | 6.1 | 6.2 | 6.2 | 6.1 | — | — |
| | Li₂O | — | — | — | — | 0.09 | 0.09 | — | — |
| | Na₂O | — | — | — | 0.18 | — | 0.18 | — | 0.30 |
| | K₂O | 0.59 | 0.56 | 1.12 | 0.28 | 0.28 | 0.28 | — | — |
| | Cl | — | — | — | 0.17 | 0.17 | 0.25 | 0.30 | 0.26 |

| | | | | | | | | |
|---|---|---|---|---|---|---|---|---|
| Glass transition temp. [° C.] | 743 | 727 | 723 | 724 | 722 | 717 | 755 | 743 |
| Expansion Coefficient [×10⁻⁷/° C.] | 36 | 40 | 43 | 39 | 39 | 40 | 34 | 34 |
| State of bubbles | good | good | good | Very | Very | Very | Not | — |
| | | | | good | good | good | good | |

### Comparative Example 1

The glass sample of Comparative Example 1 had a composition indicated in Table 4 and was a glass body that was refined using CaCl₂ as a Cl source and that was free from K₂O, i.e. R₂O. It was observed that it had many remaining bubbles and low degree of refining.

### Comparative Example 2

The glass sample of Comparative Example 2 had a composition indicated in Table 4 and was a glass body that was refined using NaCl as a Cl source and that contained R₂₀ without satisfying the relationship of the K₂O content≧the Na₂O content. In Comparative Example 2, remaining bubbles can be reduced to a certain extent, but Na ions migrate gradually from the surface even at normal temperature because Na ions that tend to diffuse in glass are contained in a certain amount or more. When this glass composition is used for a glass substrate for an information display, for example, a glass substrate for a liquid crystal display, there is a problem in that it may spread into liquid crystal devices to deteriorate performance thereof, for example.

### INDUSTRIAL APPLICABILITY

The glass composition of the present invention can be used for the applications where chemical resistance, heat resistance, and a small thermal expansion coefficient are required or where a component imposing a heavy burden on the environment, such as arsenic oxide, is avoided.

1. A glass composition, comprising, in terms of mass %:
40 to 70% of SiO₂;
5 to 20% of B₂O₃;
10 to 25% of Al₂O₃;
0 to 5% of MgO (up to and not including 5%);
0 to 20% of CaO;
0 to 20% of SrO;
0 to 10% of BaO;
0 to 1.5% of Li₂O;
0 to 1.5% of Na₂O;
0 to 1.5% of K₂O; and
to 1.5% of Cl,
wherein the sum of contents of Li₂O, Na₂O, and K₂O is 0.05 to 1.5 mass % and the content of K₂O is equal to or larger than that of Na₂O.

2. The glass composition according to claim 1, wherein the content of Cl is in a range of 0.04 to 1.5 mass %.

3. The glass composition according to claim 1, wherein the sum of contents of Li₂O, Na₂O, and K₂O is in a range of 0.07 to 1.5 mass % (from but not including 0.07 mass %).

4. The glass composition according to claim 1, wherein the content of Na₂O is in a range of 0 to 1.0 mass % (up to and not including 1.0 mass %).

5. The glass composition according to claim 1, wherein the content of K₂O is in a range of 0.05 to 1.5 mass %.

6. The glass composition according to claim 1, wherein the content of K₂O is in a range of 0.07 to 1.5 mass %.

7. The glass composition according to claim 1, wherein the content of K₂O is in a range of 0.05 to 1.5 mass %, and the content of Cl is in a range of 0.04 to 1.5 mass %.

8. The glass composition according to claim 1 that is substantially free from As₂O₃ and Sb₂O₃.

9. The glass composition according to claim 1, having a glass transition temperature in a range of 690° C. and higher.

10. A glass composition, comprising, in terms of mass %:
40 to 70% of SiO₂;
5 to 20% of B₂O₃;
10 to 25% of Al₂O₃;
0 to 10% of MgO;
0 to 20% of CaO;
0 to 20% of SrO;
0 to 10% of BaO;
0.05 to 1.5% of K₂O; and
0.04 to 1.5% of Cl.

11. The glass composition according to claim 10, comprising, in terms of mass %:
58 to 70% of SiO₂;
8 to 13% of B₂O₃;
13 to 20% of Al₂O₃;
1 to 5% of MgO;
1 to 10% of CaO;
0 to 4% of SrO;
0 to 1% of BaO;
0.05 to 1.5% of K₂O; and
0.04 to 1.2% of Cl.

12. A glass substrate for an information display, comprising a glass plate formed of a glass composition,
wherein the glass composition is a glass composition according to claim 1.

13. A glass substrate for an information display, comprising a glass plate formed of a glass composition,
wherein the glass composition is a glass composition according to claim 10.

14. A process for producing a glass composition comprising, in terms of mass %:
40 to 70% of SiO₂;
5 to 20% of B₂O₃;
10 to 25% of Al₂O₃;
0 to 10% of MgO;
0 to 20% of CaO;
0 to 20% of SrO;
0 to 10% of BaO;
0.05 to 1.5% of K₂O; and
0.04 to 1.5% of Cl,
wherein the process comprises melting a glass raw material prepared so as to obtain the glass composition, and the glass raw material contains KCl.
